(19) United States
(12) Patent Application Publication
(10) Pub. No.: US 2002/0127451 A1
(43) Pub. Date: Sep. 12, 2002

(54) Compact direct methanol fuel cell

(76) Inventors: Yiding Cao, Miami, FL (US); Zhen Guo, Miami, FL (US)

Correspondence Address: Yiding Cao, 16302 SW 68 Terrace, Miami, FL, 33193, US

(21) Appl. No.: 10/080,222

(22) Filed: Feb. 21, 2002

Related U.S. Application Data
(60) Provisional application No. 60/271,491, filed on Feb. 27, 2001.

(51) Int. Cl. H01M 8/02; H01M 8/10; H01M 8/04

(52) U.S. Cl. 429/30; 429/25; 429/32; 429/34

(57) ABSTRACT

A compact, lightweight direct methanol fuel cell unit includes a circular membrane electrode assembly (MEA) having a cathode, a proton exchange membrane (PEM), and an anode, an air flow duct on the cathode side of the MEA, an annular fuel reservoir on the anode side of the MEA which contains a mixture of methanol and water as fuel, a carbon dioxide (CO₂) relief valve communicating with the fuel reservoir, and a control unit. Due to the CO₂ release mechanism, the fuel cell is completely self-sustaining without the need for a mechanical auxiliary system. Additionally, the control unit improves the stability of the fuel cell power output and the catalysis activity of the MEA. Another embodiment of the present invention is a direct methanol fuel cell system which incorporates a number of MEAs and a fuel cell reservoir. All the cathodic electrical terminals of the MEAs are serially connected together while they are electronically communicating with the control unit. The anodic electrical terminals similarly communicate electronically with the control unit. Higher power and voltage are thus attained while maintaining a compact size of the fuel cell system.

### CROSS REFERENCES TO RELATED APPLICATIONS

This application is a continuation of provisional application No. 60/271,491 filed Feb. 27, 2001.

### TECHNICAL FIELD

This invention relates to direct methanol fuel cells and in particular the construction of a compact, lightweight fuel cell with improved load stability.

### BACKGROUND OF THE INVENTION

A fuel cell is a device that directly converts the chemical energy of reactants (a fuel and an oxidant) into low-voltage d.c. electricity. Many of the operational characteristics of fuel cell systems are superior to those of conventional power generation. Fuel cell systems have relatively constant efficiency over a wide range of unit sizes, and possess the great advantage of higher efficiencies in small sizes, which would make them suitable for applications requiring a portable power supply. In general, the fuel cell technologies can be divided into three categories, namely, fuel cells employing compressed hydrogen gas as fuel, fuel cells employing methanol reformats as fuel, and direct-methanol fuel cells. Since compressed hydrogen is at an extremely high pressure, it is very difficult to handle. In addition, a large hydrogen storage tank is needed, which could not satisfy the requirement of miniature size. Although the fuel is stored in terms of liquid methanol for a methanol reformat-based fuel cell, the methanol reformer and other vaporization and cleaning auxiliary systems drastically increase the size of a methanol reformat-based fuel cell. Unlike the other fuel cell technologies, the direct methanol fuel-cell converts methanol directly into electric energy.

Traditionally, a direct-methanol fuel cell utilizing a solid-state proton exchange membrane (PEM) as the electrolyte comprises a compressor for supplying air to the cathode, a pump for the circulation of the water/methanol mixture at the anode, and a membrane electrode assembly (MEA), which includes a cathode, a proton exchange membrane (PEM), and an anode. During operation, a methanol and water mixture as fuel is directly supplied in a liquid state to an anode, and oxygen containing gas (air) is supplied to a cathode so that the aqueous methanol solution reacts with water to obtain hydrogen ions. The chemical reactions at each electrode and the overall reaction for the cell are as follows

Anode half-cell reaction:

CH₃OH+H₂O→CO₂+6H⁺+6e⁻

Cathode half-cell reaction:

O₂+4H⁺+4e⁻→2H₂O

Overall cell reaction:

CH₃OH+1.5O₂→CO₂+2H₂O

Due to the motion of the hydrogen ion through the membrane electrolyte from the anode to the cathode, the flow of electrons within an external circuit is created, which produces available electric energy out of the fuel cell. The fuel cell can operate at room temperature and at up to 90° C. According to a preferred implementation (U.S. Pat. No. 5,945,231 of Narayanan et al. and U.S. Pat. No. 5,992,008 of Kindler), the membrane is formed from Nafion by Dupont, a perfluorinated proton-exchange membrane material. The thickness of the proton exchange membrane is in the range of 0.05-0.5 mm to be dimensionally stable. The anode consists of a Teflonised carbon paper support, upon which is spread a thin layer of platinum-ruthenium catalyst. The cathode is a gas diffusion electrode in which platinum particles are bonded to one side of the membrane.

In general, a direct methanol fuel cell is simple in structure and is suited for many applications requiring portable power supplies. While the inventors recognize many technological advancements recently described by prior arts, the current existing direct-methanol fuel cell technology cannot satisfy many of the key technical requirements for a portable system having a small size and weight due to several major factors. The fuel cell is not stand-alone and self-sustaining; it requires both a compressor and a pump for the respective air and fuel supplies. The inclusion of these supply systems makes it difficult to construct a fuel cell with a compact size. A conventional PEM fuel cell stack normally consists of a number of cells that are stacked together by metallic separator plates. Due to the nature of the flat geometry, these plates need to be considerably thick to maintain their mechanical strength. Consequently, the fuel cell stack is usually bulky and heavy. Additionally, one of the most significant limiting factors that prohibits the wide spread use of the current direct methanol technology is the maintenance of the fuel cell stability related to the catalysis activity. When running on a continuous load, the ‘steady-state’ activity of the catalysts, or the cell voltage, continues to decline over time. The cause of this decay in the catalyst activity is that the long-term stability of catalysts for methanol electro-oxidation at the anode is poor. Even after the initial rapid decay of activity to the pseudo steady-state, the activity continues to steadily decline over hundreds of minutes. The effect is exhibited by both platinum and bimetallic catalysts. The present invention has been made to overcome the difficulties described above.

### SUMMARY OF THE INVENTION

It is an objective of the present invention to provide a compact, lightweight direct methanol fuel cell unit that eliminates the need for an air compressor or a fuel pump. The fuel cell unit comprises a circular membrane electrode assembly (MEA), an annular fuel reservoir, a circular air flow duct, and a CO₂ relief valve. The MEA includes a cathode, a proton exchange membrane (PEM), and an anode. Because of the circular geometry, lightweight nonmetallic materials may be used for the supporting layers on both anode and cathode sides of the MEA. Additionally, because of the CO₂ release mechanism through the CO₂ relief valve, the mechanical pump that is traditionally used for fuel circulation and CO₂ venting is eliminated.

Another objective of this invention is to provide a control unit to improve the performance stability of the fuel cell. This control unit would deliver a constant power output to the external load. The control unit is driven by the direct-methanol fuel cell itself; no external power source is needed. It acts as a pulsed load on the cell; hence, the voltage and current produced by the cell change in very short periods, which will recover the activity of the methanol electrode to the initial activity, and at the same time this procedure would not affect the performance of the air electrode.

Yet another objective of the invention is to provide a complete compact fuel cell system that integrates a number of the fuel cell units described above. The compact fuel cell system comprises a number of MEAs and associated air flow ducts, a fuel reservoir shared by these MEAs, a control unit, a CO₂ relief valve, and a fuel feeding valve. Each fuel cell unit has one cathodic electrical terminal and one anodic electrical terminal. All the cathodic electrical terminals are serially connected together, while they are electronically communicating with the control unit. The anodic electrical terminals similarly communicate electronically with the control unit. Through these interconnections, the fuel cell units may be controlled through a single control unit. As a result of the interconnection of the MEAs, the total power output of the fuel cell system as well as its voltage are substantially increased.

### BRIEF DESCRIPTION OF THE DRAWINGS

FIG. 1 is a schematic perspective illustration of a methanol-air PEM fuel cell unit;

FIG. 2 is a vertical cross-sectional illustration of the fuel cell unit as shown in FIG. 1;

FIG. 3 is an enlarged fragmentary view of a portion of FIG. 2 at location A;

FIG. 4 is a schematic perspective illustration of a compact fuel cell system integrating a number of fuel cell units;

FIG. 5 is a vertical cross-sectional illustration of the fuel cell system as shown in FIG. 4; and

FIG. 6 is a cross-sectional illustration of the fuel cell system taken along lines A-A in FIG. 4.

### DETAILED DESCRIPTION OF THE INVENTION

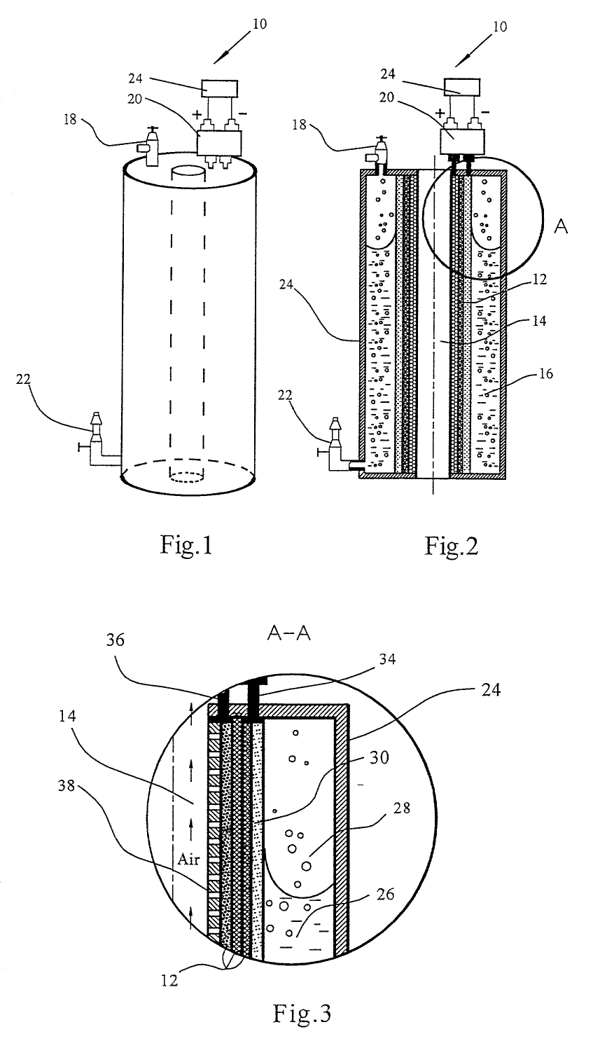

FIG. 1 shows a direct methanol fuel cell unit 10 according to a preferred form of the present invention, FIG. 2 is a-vertical cross-sectional illustration of the fuel cell unit 10, and FIG. 3 is an enlarged view of the interior structure of the fuel cell unit 10. With reference to FIG. 2, the fuel cell unit 10 generally comprises a circular membrane electrode assembly (MEA) 12 having a cathode, a proton exchange membrane (PEM), and an anode, a circular air flow duct 14 on the cathode side of the MEA 12, an annular fuel reservoir 16 on the anode side of the MEA 12 with a CO₂ release mechanism, a CO₂ relief valve 18, and a control unit 20. Initially, an amount of water/methanol mixture is filled within the annular reservoir as the fuel. Turning now to FIG. 3, there is provided an enlarged view of the interior structure of the fuel cell unit 10. A porous layer 30 with interconnected pores and an appropriate thickness and pore size is provided at the inner surface of the reservoir that is in contact with the anode of the MEA 12. A metallic layer with a high conductivity can be coated at the surface of the porous layer that is in direct contact with the anode of the MEA 12 for electric current collection at the anode, and is integrated with an anodic terminal 34. The porous layer 30 could also enhance the mechanical strength of the MEA 12 from the anode side. Due to the capillary force effect, the porous layer helps to spread the water/methanol mixture over the entire surface of the anode for the fuel supply purpose.

During operation CO₂ is generated at the anode and vented to the reservoir space 28 not occupied by the fuel 26. As more and more CO₂ accumulates in the reservoir, the pressure in the reservoir is gradually increased. When the pressure reaches a certain level, the CO₂ relief valve 18 as shown in FIG. 2 automatically opens briefly, which releases CO₂ and effectively maintains the reservoir at a constant pressure. The pressure relief valve 18 is designed and set so that the pressure differential between the anode and the cathode is maintained within an acceptable level, and the water/methanol mixture will not leak out of the reservoir with the CO₂. To supply additional fuel to the reservoir 16, a separate fuel tank (not shown in the figure) is connected to a feeding valve 22 that is shown in FIG. 2 and communicates with the fuel reservoir 16. As a result, the size of the reservoir can be drastically reduced and a fuel cell unit of a small size can be constructed.

Generally, the PEM-based fuel cell could work at a temperature between room temperature and 90° C. The optimum working temperature is considered to be between 50-80° C. Within this working temperature range, the air temperature within the air flow duct 14 is considerably higher than that of ambient air. Due to the buoyancy effect, the hot air within the duct is induced to flow upwards, which sucks cooler ambient air into the flow duct. As a result, a continuous and relatively strong air flow is created along the duct. Because the air is in direct contact with the cathode of the MEA 12, it supplies the oxygen needed for the chemical reaction at the Cathode. Since the air flow is relatively strong, the water generated during the reaction at the cathode is also being carried out of the fuel cell. To enhance the mechanical strength of the MEA from the cathode side, a perforated air flow duct wall 38 could be used as shown in FIG. 3. A metallic layer with high conductivity can also be coated at the surface of the air flow duct wall that is in direct contact with the cathode of the MEA 12, and is integrated with a cathodic terminal 36 for the purpose of electric current collection at the cathode. To prevent water clogging, the surface of the duct wall 38 that is in contact with air can be wet-proofed with a coating of Teflon-type material. The perforated wall 38 can also be replaced with an appropriate porous structure with interconnected pores. In addition, for a given working temperature and electric energy load, an optimum air flow duct geometry can be identified that could provide a maximum air flow rate to the cathode. It should be noted that, although the fuel cell unit is illustrated in a vertical position in FIG. 2, the fuel cell would work at an arbitrary tilt angle.

Through the description above, the advantages of the fuel cell unit of the present invention over conventional fuel cells are clear. The fuel cell unit of the present invention is completely stand-alone and self-sustaining, which completely eliminates the use of an air compressor for the cathode and water/methanol pump for the anode. In addition, the fuel cell unit of the present invention would have a circular geometry that is clearly advantageous over the conventional flat geometry.

As mentioned in the background of the invention, one of the most significant limiting factors that prohibits the wide spread use of the current direct methanol fuel cell technology is the maintenance of the fuel cell stability related to the catalysis activity. This issue is further discussed here. Researchers at Shell Research [McNico et al., “Direct Methanol-Air Fuel Cells for Road Transportation,” Journal of Power Sources, Vol. 83, 1999, pp. 15-31] and others have noticed that switching the current off for short periods of time results in a return of the catalytic activity to its pseudo steady-state level. This fortunate observation encouraged Shell Research to conduct life tests using various programmed on/off sequences. Very little loss in activity was observed through hundreds of hours [McNico et al., “Direct Methanol-Air Fuel Cells for Road Transportation,” Journal of Power Sources, Vol. 83, 1999, pp. 15-31]. In fact, a programmed sequence was developed to mimic the ECE 15 urban driving cycle of a vehicle and over 1000 hours of steady operation was obtained. This property of self-recovery which the catalysts possess may even enable a methanol-air fuel cell to deliver a higher continuous power output. The Shell researchers attributed the recovery to the removal of the carbonaceous residue at the open-circuit potential. Other research such as that of Hamnett et al. [Hamnett et al., “Long-Term Poisoning of Methanol Anodes,” Ber Bunsenges Phys Chem, Vol. 94, 1990, pp. 1014-1020] subsequently observed the same phenomenon but ascribed its cause, perhaps more reasonably, to the removal of inactive platinum oxide species at open circuit. Unlike transportation-related direct methanol fuel cells, the power supply of a portable device may be continuous. As a result, the activity decay of the catalysts is more severe. To overcome this difficulty, a control unit 20 as shown in FIG. 2 is constructed based on the phenomenon discovered by Shell Research. This control unit applies a continuous instantaneous pulsed load cycle to the cell to improve electric performance and power output. Similar techniques are also applied in other electrochemical devices and processes, such as electroplating, to improve performance (reduced power input) or to improve quality. However, possible improvement in cell power must be balanced against the fact that during the relaxation period no power can be obtained from the cell. In this invention, the electric control unit 20 is added between the methanol-air fuel cell and the external load 24, as shown in FIG. 2. The control unit 20 is driven by the direct methanol fuel cell itself; no external power source is needed. It acts as a pulsed load on the cell; hence, the voltage and current produced by the cell change in very short periods, which will recover the activity of the methanol electrode to the initial activity, and at the same time this procedure would not affect the performance of the air electrode. The control unit would include a capacitor, which is charged in the pulsed load period and discharges in the relaxation period. During the pulsed load period, the cell charges the capacitor in the control unit; at the same time, it provides power to the external load. Before the cell reaches steady state, the control unit removes the load which is followed immediately by a relaxation period. During the relaxation period of the cell, electricity will be discharged from the capacitor and rectified by the control unit. So the output of the control unit is always d.c. electricity, which can be used by the external load.

One of the objectives of the present invention is to provide a lightweight fuel cell. To -achieve this goal, a lightweight material such as polyethylene can be used for the fuel cell container 24 as shown in FIG. 2. The perforated wall 38 of the air flow duct can also be made of polyethylene. As mentioned earlier, the perforated wall 38 can be replaced with a porous wall having interconnected pores. In this case, a polyethylene porous wall can be used. A thin layer of metal can be coated on the surface of the perforated or porous wall that is in direct contact with the cathode of the MEA 12. This layer of metal serves as a metallic current collector, which is in electric communication with the cathodic electrical terminal 36. The metal layer can be coated by employing a coating technique, including but not limited to spray, painting, screen printing, brushing or electroplating. Similarly, the support porous layer 30 at the anode side of the MEA 12 can be made of a lightweight material that is laminated on the anode to maintain good mechanical strength, with its interior surface (facing the anode) coated with a layer of metal by an appropriate coating method. This layer of metal also serves as a current collector, which is in electric communication with the anodic electrical terminal 34.

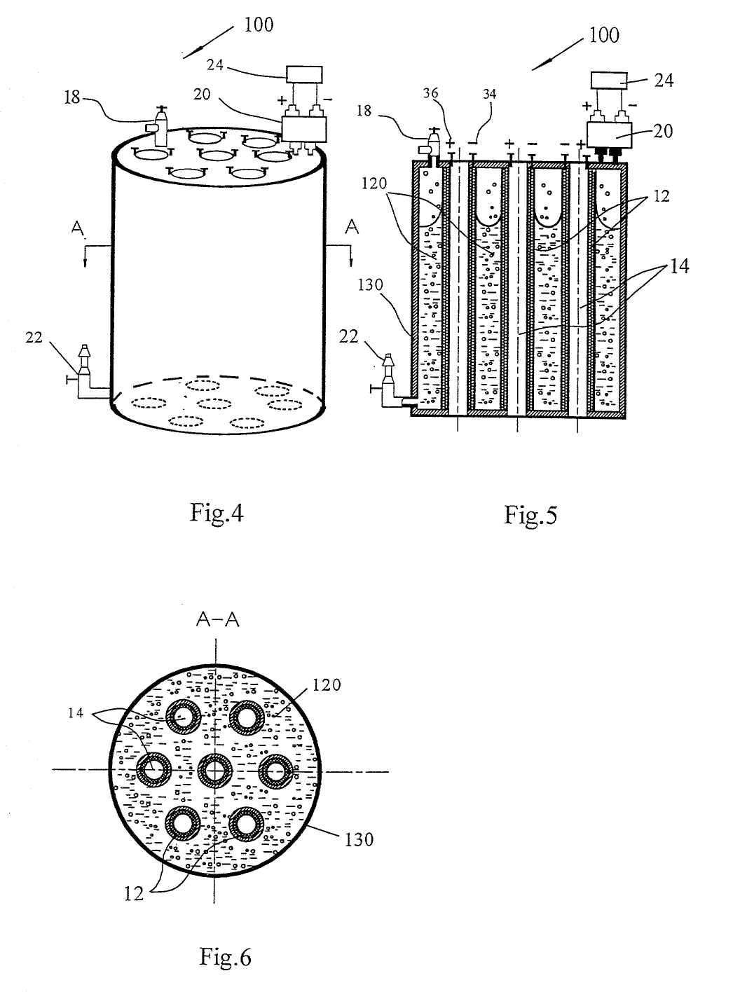

The electromotive force, or emf, of the direct methanol fuel cell unit 10 as described above working within a temperature range of 50-90° C. is about 0.7 V. This voltage is not sufficient for some applications that require a relatively high power. To overcome this difficulty, a number of fuel cell units 10 can be connected in series to generate sufficiently high power at a sufficiently high voltage. FIG. 4 shows a compact fuel cell system 100 according to a preferred form of the present invention, FIG. 5 is a vertical cross-sectional illustration of the fuel cell system 100, and FIG. 6 is a cross-sectional view of the fuel cell system taken along lines A-A in FIG. 4. The fuel cell system 100 integrates a number of MEAs 12 with the associated air flow ducts 14 from individual fuel cell units 10. These MEAs 12 share a common fuel reservoir 120 as shown in FIG. 6 to reduce the overall volume of the system. Each MEA would also have a porous layer 30 and a perforated wall (or a porous wall with interconnected pores) 38 provided on the anode and cathode sides of the MEA, respectively. As shown in FIG. 5, each fuel cell unit has one cathodic electrical terminal 36 and one anodic electrical terminal 34. All the cathodic electrical terminals 36 are serially connected together, and may electronically communicate with the control unit 20. The anodic electrical terminals 34 are also connected in series and may communicate electronically with the control unit 20. Through these interconnections, the fuel cell units may be controlled through a single control unit 20. The CO₂ relief valve 18 of the fuel cell system 100 has the same function as that of the relief valve of the fuel cell unit 10 and serves the commonly shared fuel reservoir 120 that is enclosed by a container 130. It should be noted that although the system is illustrated in a vertical position, it could work at any tilt angle. In this case, additional relief valves may be needed at appropriate locations.

Similar to the fuel cell unit 10 as illustrated in FIGS. 1-3, the container 130 and the air flow duct wall 38 can be made of a lightweight material, such as polyethylene. Additionally, a lightweight material such as acetal plastic can be used for the bodies of the CO₂ relief valve 18 and the fuel feeding valve 22 to reduce the weight of the portable fuel cell system 100.

It will thus be seen that the invention effectively attains the objectives set forth above. It is intended that all matter contained in the above specification or shown in the accompanying drawings be interpreted as illustrative and not in a limiting sense. Any changes, modifications, and variations of the subject invention will be apparent to those skilled in the art after considering this specification together with the accompanying drawings.

We claim:

1. A fuel cell unit comprising:
a circular membrane electrode assembly (MEA), said MEA includes a cathode, a proton exchange membrane (PEM), and an anode, at least a cathodic terminal and an anodic terminal, an air flow duct on the cathode side of the MEA, an annular fuel reservoir on the anode side of the MEA, said fuel reservoir contains a mixture of methanol and water as fuel, and at least a carbon dioxide (CO₂) relief valve communicating with said fuel reservoir, thereby fuel is supplied through said fuel reservoir to said anode of the MEA and oxygen is supplied from said air flow duct to said cathode of the MEA, and thereby electricity is generated in the fuel cell unit and is delivered through said cathodic terminal and said anodic terminal to an external power load.

2. The fuel cell unit of claim 1 further comprising a fuel feeding valve, said feeding valve communicates with an external fuel tank for additional fuel supply to said fuel reservoir.

3. The fuel cell unit of claim 1 further comprising a control unit, said control unit applies a continuous instantaneous pulsed load cycle to the fuel cell unit to improve the stability of the fuel cell power output and the catalysis activity of the MEA.

4. The fuel cell unit of claim 1 further including a porous structure on the anode side of the MEA, whereby the fuel is supplied to said anode through capillary force effect and whereby the mechanical strength of the MEA is enhanced.

5. The fuel cell unit of claim 4 wherein said porous structure is coated with a thin layer of metal on the surface of the porous structure that is in direct contact with the anode of the MEA, said thin metal layer serves as a metallic current collector and is in electric communication with said anodic electrical terminal.

6. The fuel cell unit of claim 1 further including a porous structure on the cathode side of the MEA, whereby the mechanical strength of the MEA is enhanced.

7. The fuel cell unit of claim 6 wherein said porous structure is coated with a thin layer of metal on the surface of the porous structure that is in direct contact with the cathode of the MEA, said thin metal layer serves as a metallic current collector and is in electric communication with said cathodic electrical terminal.

8. The fuel cell unit according to claim 1, wherein said CO₂ relief valve releases CO₂ from said fuel reservoir at a set reservoir pressure and retains the fuel within the reservoir, whereby the fuel reservoir is effectively maintained at a set pressure.

9. A fuel cell system comprising:
a plurality of circular membrane electrode assemblies (MEAs), each said MEA includes a cathode, a proton exchange membrane (PEM), an anode, at least a cathodic terminal and an anodic terminal, a plurality of air flow ducts, each said air flow duct being on the cathode side of the associated MEA, a fuel reservoir on the anode side of the MEAs, said fuel reservoir contains a mixture of methanol and water as fuel, and at least a carbon dioxide (CO₂) relief valve communicating with said fuel reservoir, thereby fuel is supplied through said fuel reservoir to said anodes of the MEAs and oxygen is supplied from said air flow ducts to said cathodes of the MEAs, and thereby electricity is generated in the fuel cell system and is delivered through said cathodic terminals and said anodic terminals to an external power load.

10. The fuel cell system according to claim 9, wherein said cathodic terminals are connected in series and wherein said anodic terminals are connected in series.

11. The fuel cell system of claim 9 further comprising a fuel feeding valve, said feeding valve communicates with an external fuel tank for additional fuel supply to said fuel reservoir.

12. The fuel cell system of claim 9 further comprising at least a control unit, said control unit applies a continuous instantaneous pulsed load cycle to the fuel cell system to improve the stability of the fuel cell power output and the catalysis activity of the MEAs.

13. The fuel cell system of claim 9 further including a porous structure on the anode side of each MEA, whereby the fuel is supplied to said anode through capillary force effect and whereby the mechanical strength of the MEA is enhanced.

14. The fuel cell unit of claim 13 wherein said porous structure is coated with a thin layer of metal on the surface of the porous structure that is in direct contact with the anode of the MEA, said thin metal layer serves as a metallic current collector and is in electric communication with said anodic electrical terminal.

15. The fuel cell system of claim 9 further including a porous structure on the cathode side of each MEA, whereby the mechanical strength of the MEA is enhanced.

16. The fuel cell unit of claim 15 wherein said porous structure is coated with a thin layer of metal on the surface of the porous structure that is in direct contact with the cathode of the MEA, said thin metal layer serves as a metallic current collector and is in electric communication with said cathodic electrical terminal.

17. The fuel cell system according to claim 9, wherein said CO₂ relief valve releases CO₂ from said fuel reservoir at a set reservoir pressure and retains the fuel within the reservoir, whereby the fuel reservoir is effectively maintained at a set pressure.
